(19) United States
(12) Patent Application Publication
(10) Pub. No.: US 2009/0141679 A1
(43) Pub. Date: Jun. 4, 2009

(54) METHOD FOR FORMING FRAME IN WIDEBAND WIRELESS COMMUNICATION SYSTEM USING MULTI-ANTENNA

(75) Inventors: Yoo-Seung SONG, Daejon (KR); Jee-Yon CHOI, Daejon (KR); Hyun-Gu PARK, Seoul (KR); Yun-Joo KIM, Suwon-si (KR); Kyoung-Hee SONG, Jeonju-si (KR); Sok-Kyu LEE, Daejon (KR)

Correspondence Address: CANTOR COLBURN, LLP, 20 Church Street, 22nd Floor, Hartford, CT, 06103, US

(73) Assignee: ELECTRONICS AND TELECOMMUNICATIONS RESEARCH INSTITUTE, Daejon (KR)

(21) Appl. No.: 12/129,897

(22) Filed: May 30, 2008

(30) Foreign Application Priority Data
Dec. 3, 2007 (KR) 10-2007-0124387

(51) Int. Cl. H04Q 7/00

(52) U.S. Cl. 370/329

(57) ABSTRACT

A method for forming a frame in a wireless communication system is provided. In the method, a plurality of preamble symbols are disposed. Then, a signal symbol is disposed at a predetermined position among the plurality of preamble symbols. At least one of data symbols is disposed after the plurality of preamble symbols.

### CROSS-REFERENCE(S) TO RELATED APPLICATIONS

The present invention claims priority of Korean Patent Application No. 10-2007-0124387, filed on Dec. 3, 2007, which is incorporated herein by reference.

### BACKGROUND OF THE INVENTION

1. Field of the Invention

The present invention relates to a method for forming a frame of a wireless communication system having a multi-antenna; and, more particularly, to a method for forming a frame in a wireless communication system using a multi-antenna in order to efficiently distribute resources to a plurality of users and estimate a wireless channel by forming a frame having a plurality of preambles and a super-frame having a plurality of frames.

This work was supported by the IT R&D program of MIC/IITA [2006-S-002-02, “IMT-Advanced Radio Transmission Technology with Low Mobility”

2. Description of Related Art

In orthogonal frequency multiplexing (OFDM) wireless communication system, a downlink frame generally includes a preamble at a forepart of the downlink frame, a plurality of data symbols after the preamble, and pilot symbols between adjacent predetermined data symbols throughout the overall downlink frame.

Here, the preamble includes more than two same patterns that are repeated in a time domain, and the pilot symbol uses one of the two same patterns of the preamble.

Also, the number of the preamble is relative to the number of antennas and is used to grasp channel characteristics of each antenna. The pilot symbols are disposed between predetermined data symbols according to varying channel characteristics.

Therefore, the OFDM wireless communication system estimates a channel state which varies in a time domain using a downlink frame and decodes a receiving signal by correcting a distorted signal.

One base station covers a predetermined area, and there are several tens of users in one area. In order to provide a good quality service to those users, data must be transferred to the users through efficient resource allocation. That is, necessary system parameters and information for resource allocation must be transmitted to each of the users.

Therefore, it is necessary to have an uplink/downlink frame structure that allows efficient resource scheduling between users and to minimize overhead information for transferring necessary communication information to users.

In order to guarantee a certain level of data quality to users, it is necessary to use a plurality of auxiliary uplink and downlink frames and to have a structure that provides the optimal performance using minimum auxiliary resources.

For this, the OFDM wireless communication systems according to the related art transmits downlink frames after inserting broadcast information such as resource allocation information to all of the downlink frames.

Since the broadcast information is inserted into all of the downlink frames when the downlink frames are transmitted, a user must perform a decoding operation whenever the user receives the downlink frames. Therefore, power may be unnecessarily consumed. Furthermore, a data transfer rate may be lowered because the number of data symbols in the frame is reduced if overhead information becomes larger.

### SUMMARY OF THE INVENTION

An embodiment of the present invention is directed to providing a method for forming a frame of a wireless communication system using a multi-antenna in order to efficiently distribute resources to a plurality of users and estimate a wireless channel by forming a frame having a plurality of preambles and a super-frame having a plurality of frames.

In accordance with an aspect of the present invention, there is provided a method for forming a frame of a wireless communication system, including: disposing a plurality of preamble symbols; disposing a signal symbol at a predetermined position among the plurality of preamble symbols; and disposing at least one of data symbols after the plurality of preamble symbols.

In accordance with another aspect of the present invention, there is provided a method for forming a frame of a wireless communication system, including: disposing a plurality of uplink frames and a plurality of downlink frames with an inter frame space between each of the downlink frames and a corresponding uplink frames; storing broadcast channel information in a data field of a first downlink frame; and disposing at least one of short uplink frames after a last downlink frame.

The method for forming a frame according to the present invention forms an uplink/downlink frame for short range wireless communication suitable for orthogonal frequency division multiplexing (OFDM), time division multiple access (TDMA), and time division duplex (TDD). Therefore, a signal receiving quality can be improved, and resources can be effectively allocated among users.

Also, the method for forming a frame according to the present invention forms a frame having a structure suitable for a wideband multi antenna system.

Furthermore, the method for forming a frame according to the present invention form a frame suitable for wideband channel characteristics, for channel estimation for multi-antennas, and for a low speed or a high speed wireless channel.

Moreover, the method for forming a frame according to the present invention forms a frame having the optimal number and positions of symbols because a plurality of overhead symbols are used in a wireless channel environment.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### BRIEF DESCRIPTION OF THE DRAWINGS

FIG. 1 is a diagram illustrating a structure of a super frame of a wireless communication system having a multi-antenna in accordance with an embodiment of the present invention.

FIG. 2 is a diagram illustrating a structure of an uplink frame and a downlink frame for a wireless communication system having a multi-antenna in accordance with an embodiment of the present invention.

FIG. 3 is a diagram illustrating a short uplink frame structure of a wireless communication system having a multi-antenna in accordance with an embodiment of the present invention.

FIG. 4 is a flowchart illustrating a method for forming a super frame of a wireless communication system having a multi-antenna in accordance with an embodiment of the present invention.

FIG. 5 is a flowchart illustrating a method for forming an uplink/downlink frame of a wireless communication system having a multi-antenna in accordance with an embodiment of the present invention.

### DESCRIPTION OF SPECIFIC EMBODIMENTS

The advantages, features and aspects of the invention will become apparent from the following description of the embodiments with reference to the accompanying drawings, which is set forth hereinafter. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

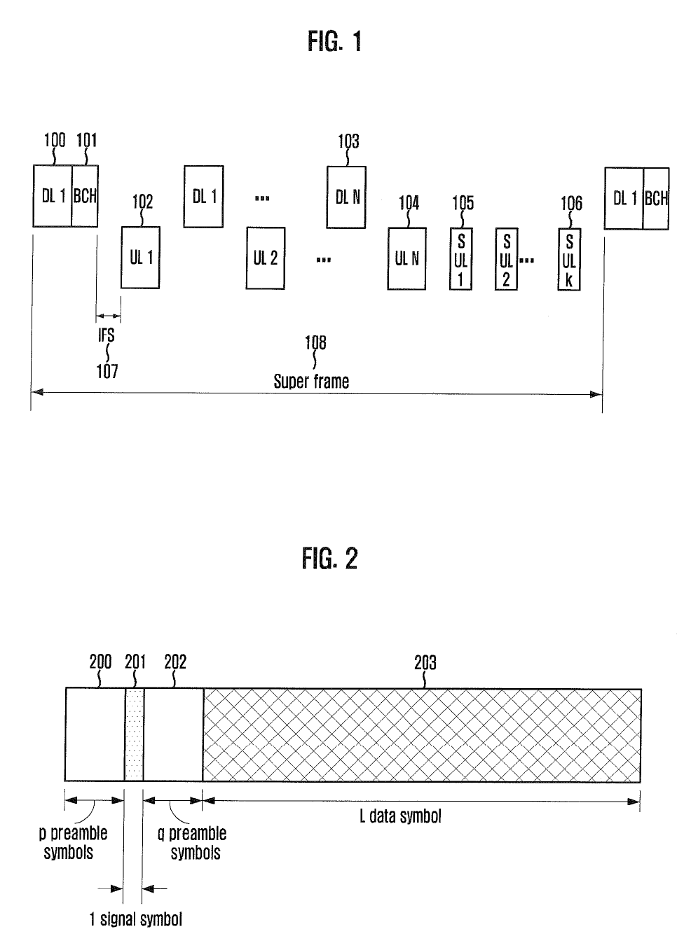

FIG. 1 is a diagram illustrating a structure of a super frame of a wireless communication system having a multi-antenna in accordance with an embodiment of the present invention.

Referring to FIG. 1, the super frame according to the present embodiment includes a plurality of uplink/downlink frames and a plurality of short uplink frames.

The downlink frame 100 is a frame transmitted from a base station to a terminal. The super frame 108 includes N downlink frames.

The uplink frame 102 is a frame transmitted from a terminal to a base station. The super frame 108 includes N uplink frames.

The short uplink frame 105 is disposed at the next of the last uplink frame 104 which is the n^{th} uplink frame. The super frame 108 includes k short uplink frames.

The super frame 108 also includes an inter-frame space (IFS) 107 between each downlink frame and a corresponding uplink frame.

In the super frame, a data field 101 of the first downlink frame stores broadcast channel information (BCH) and is transmitted to all of users in a corresponding area (in band signaling). The data field 101 is used as a reference of a starting position of a super frame. Here, the broadcast channel information includes information about link frame resource allocation and the number and positions of short uplink frames.

The plurality of uplink/downlink frames, which form a super frame, are allocated to one or more users and used for receiving and transmitting data. The information about the positions and the number of the short uplink frames is information for users who try initial access. This information enables a user to perform initial access without interfering with the other users in communication.

In time division multiple access (TDMA), link frames of a super frame are divided by a time slot, and each of users identifies and uses allocated link frames by a corresponding time slot. Or, link frames of a super frame may be divided by identifying users based on data symbols in a frame and each of the users may use corresponding one of divided link frames. In case of dividing the link frames by data symbols, data allocation region of each user can be identified through a signal symbol that forms a frame.

FIG. 2 is a diagram illustrating a structure of an uplink frame and a downlink frame for a wireless communication system having a multi-antenna in accordance with an embodiment of the present invention.

Referring to FIG. 2, the uplink/downlink frame in a wireless communication system having a multi-antenna according to the present embodiment includes preamble fields 200 and 202 having a plurality of preamble symbols, for example, q+p preamble symbols, a signal field 201 having one signal symbol between the preamble fields 200 and 202, and a data field 203 having L data symbols after the preamble field 202. Here, q and p may be an integer number.

The position of the signal field 201 is decided by controlling values of q and p for efficiently operating the wireless communication system.

The sum of the values of p and q, which are the number of preamble symbols in the preamble fields 200 and 202, is set to be equal to or larger than the number of multi-antennas. Here, each value of p and q is equal to or larger than 0.

The number L of data symbols in the data field 203 is changed independently to uplink/downlink according to a traffic amount of the uplink/downlink. Such information is shared to all of users in the same area through BCH or a signal symbol. That is, if the number of data symbols in the uplink is equal to that in the downlink, the uplink/downlink transmission ratio is 1:1. When the traffic of the downlink increases two times, the ratio becomes 2:1. Here, a value of L for a downlink, which is a factor for deciding the ratio, becomes two times of that for an uplink.

Also, one data symbol includes a plurality of pilot tones.

Furthermore, the signal symbol applies the lowest modulation and coding scheme (MCS) level that supports the wireless communication system, and data symbols transmit basic information for decoding and demodulation.

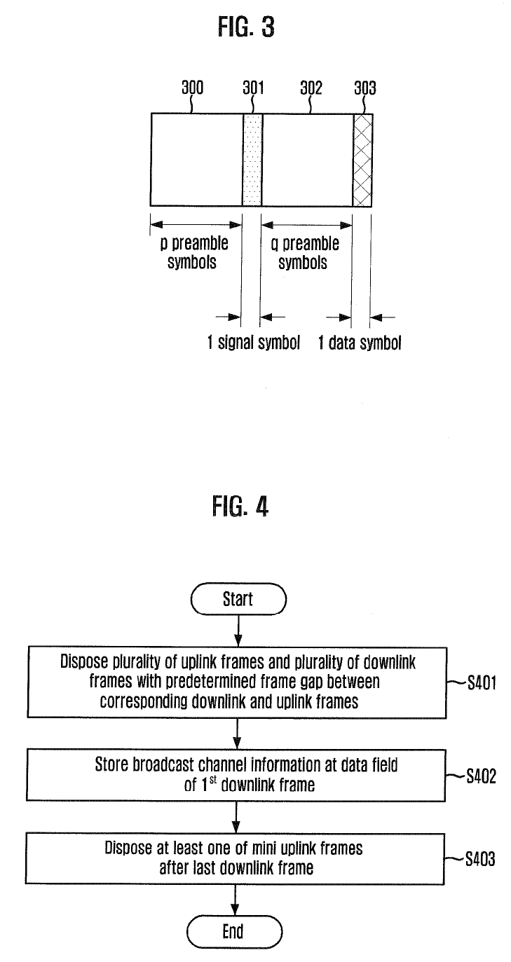

FIG. 3 is a diagram illustrating a short uplink frame structure of a wireless communication system having a multi-antenna in accordance with an embodiment of the present invention.

Referring to FIG. 3, the short uplink frame of the wireless communication system having a multi-antenna according to the present embodiment includes preamble fields 300 and 302 having a plurality of preamble symbols, for example, q+p preamble symbols, a signal field 301 having one signal symbol between the preamble fields 300 and 302, and a data field 303 having one data symbol after the preamble field 202. Here, q and p may be an integer number.

The position of the signal field 301 is decided by controlling values of q and p for efficiently operating the wireless communication system.

The sum of the values of p and q, which are the number of preamble symbols in the preamble fields 300 and 302, is set to be equal to or larger than the number of multi-antennas. Here, each value of p and q is equal to or larger than 0.

Here, one data symbol is used to efficiently transmit a small amount of data to a base station. That is, a terminal uses the data symbol to transfer acknowledgment information (Ack) for received data or transfers initial information to a base station.

If the number of users trying initial access increases, the number of short uplink frames may increase in proportion to the number of users, thereby improving a success rate of initial access.

The signal symbol applies the lowest modulation and coding scheme (MCS) level that supports the wireless communication system, and data symbols transmit basic information for decoding and demodulation.

The short uplink frames are mainly used for transferring bandwidth request information of users who try initial access or for transferring ACK feedback of a terminal for a downlink frame. Here, the number of short uplink frames may vary according to the number of users trying to access an access point (AC).

Hereinafter, information stored in a signal field in a downlink frame of a wireless communication system having a multi antenna according to the present embodiment will be described with reference to Table 1.

TABLE 1

| | Size | |
|---|---|---|
| Syntax | [bits] | Notes |
| Length | 8 | Signal field total length [bits] |
| STA number, M | 4 | Station number (Max STA number will be |
| | | 16.) |
| Reserved | 4 | |
| For(n=0; n<M; n++) { | | |
| DL MCS set index | 4 | |
| SSN | 4 | Starting Symbol Number |
| Symbol Length | 8 | Symbol length |
| } | | |
| Reserved | 8 | |
| CRC | 32 | Errors check purpose. |

In Table 1, ‘Length’ denotes a length of data (signal symbol) transmitted through a signal field, which is expressed in bits.

‘STA-number’ denotes station numbers of terminals that will decode a corresponding frame.

‘DL_MAC_set_index’ denotes an index of combination used in a modulation combination set of a physical channel which is transmitted to corresponding terminals. ‘SSN’ is a starting symbol number and denotes information about a starting position of a symbol applied to a corresponding terminal in a data field. ‘Symbol_Length’ denotes the number of symbols applied to a corresponding terminal. Here, ‘DL_MCS_set_index’, ‘SSN’, and ‘Symbol_Length’ are transmitted to each of terminals when a corresponding frame is received and decoded.

‘CRC’ is cyclic redundancy checking (CRC) which is used to check where an error is generated in received signal field information.

Hereinafter, information stored in a signal field in an uplink frame of a wireless communication system having a multi-antenna will be described with reference to Table 2.

TABLE 2

| Syntax | Size [bits] | Notes |
|---|---|---|
| Length | 8 | Signal field total length [bits] |
| STA number, M | 4 | Station number |
| | | (Max STA number will be 16.) |
| Reserved | 4 | |
| For(n=0; n<M; n++) { | | |
| UL MCS set index | 4 | |
| SSN | 4 | Starting Symbol Number |
| Symbol Length | 8 | Symbol length |
| } | | |
| CQI | 4 | DL channel quality indication. |
| | | 1000 - no indication |
| Reserved | 4 | |
| CRC | 32 | Errors check purpose. |

In Table 2, ‘Length’ denotes a length of data (signal symbol) transmitted through a signal field, which is expressed in bits.

‘STA_number’ denotes station numbers of terminals that will decode a corresponding frame.

‘DL_MAC_set_index’ denotes an index of combination used in a modulation combination set of a physical channel which is transmitted to corresponding terminals. ‘SSN’ is a starting symbol number and denotes information about a starting position of a symbol applied to a corresponding terminal in a data field. ‘Symbol_Length’ denotes the number of symbols applied to a corresponding terminal. Here, ‘DL_MCS_set_index’, ‘SSN’, and ‘Symbol_Length’ are transmitted to each of terminals when a corresponding frame is received and decoded.

‘CQI’ denotes an index value for each level when signal-to-noise ratio (SNR) of a downlink receiving signal is identified by predetermined levels.

‘CRC’ is used to check whether an error is generated in received signal field information.

When different modulation and coding schemes are applied to each of multi-antennas for transmitting and receiving data through the multi-antenna, combinations of all applicable schemes will be described with reference to Table 3.

TABLE 3

| MCS set | | | Constellation | | Number of Transmit | |
|---|---|---|---|---|---|---|
| index | Code rate | | size | | Antenna | |
| 0 | ⅔ | ⅚ | 6 | 6 | 2 | 6 |
| 1 | ¾ | ⅚ | 4 | 6 | 2 | 6 |
| 2 | ½ | ⅔ | 4 | 6 | 2 | 6 |
| 3 | ½ | ¾ | 2 | 4 | 2 | 6 |
| 4 | ½ | ½ | 2 | 2 | 2 | 6 |
| 5 | ½ | 0 | 2 | 0 | 1 | 0 |
| . . . | | | | | | |

In Table 3, ‘MCS_set_index’ denotes an index for combination of ‘Code_rate’ and ‘Constellation_size’ applied to each of multi antennas.

‘Constellation-size’ denotes a phase shift scheme. That is, 2 denotes quadrature phase shift keying (QPSK), 4 denotes 16 phase shift keying (PSK), and 6 denotes 64 PSK.

In the present exemplary embodiment, eight antennas are divided into two groups. ‘Code_rate’ and ‘Constellation_size’ applied to each of groups will be shown as various combinations.

Combinations of ‘Code_rate’ and ‘Constellation_size’ for all of multi-antennas can be shown as Table, and each of the combinations can be managed by assigning an index ‘MCS_set_index’

Table 4 is an example of dividing signal-to-noise ratio (SNR) of a receiving signal by predetermined levels and managing each of the levels with 4-bit CQI index.

TABLE 4

| SNR | CQI |
|---|---|
| SNR < 5 dB | 0000 |
| 5 dB ≦ SNR < 10 dB | 0001 |
| 10 dB ≦ SNR < 15 dB | 0010 |
| 15 dB ≦ SNR < 20 dB | 0011 |
| 20 dB ≦ SNR < 25 dB | 0100 |
| 25 dB ≦ SNR < 30 dB | 0101 |
| 30 dB ≦ SNR | 0110 |

Here, the levels of SNR may be further divided into maximum 2, which is the number of bits allocated to CQI.

FIG. 4 is a flowchart illustrating a method for forming a super frame of a wireless communication system having a multi-antenna in accordance with an embodiment of the present invention.

At step S401, a plurality of uplink frames and a plurality of downlink frames are disposed with an inter-frame space between each of predetermined downlink frames and a corresponding uplink frame.

At step S402, broadcast channel information is stored in a data field of the first downlink frame.

Then, at least one of short uplink frames is disposed after the last downlink frame at step S403.

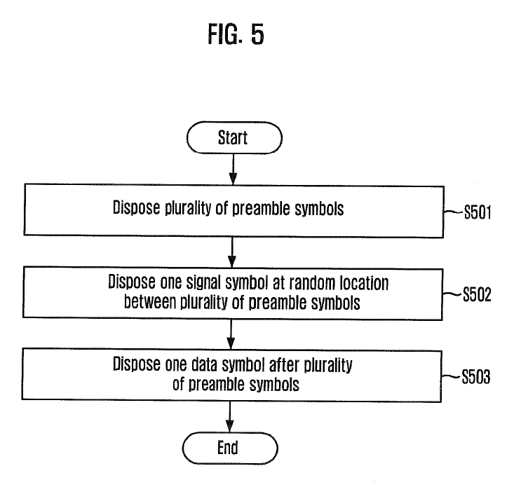

FIG. 5 is a flowchart illustrating a method for forming an uplink/downlink frame of a wireless communication system having a multi-antenna in accordance with an embodiment of the present invention.

At first, a plurality of preamble symbols are disposed at step S501.

At step S502, one signal symbol is disposed at a predetermined position among the plurality of preamble symbols.

At least one of data symbols is disposed after the plurality of preamble symbols at step S503.

Here, if one data symbol is disposed after the plurality of preamble symbol, it becomes a short uplink frame.

As described above, the technology of the present invention can be realized as a program. A code and a code segment forming the program can be easily inferred from a computer programmer of the related field. Also, the realized program is stored in a computer-readable recording medium, i.e., information storing media, and is read and operated by the computer, thereby realizing the method of the present invention. The recording medium includes all types of recording media which can be read by the computer.

According to the present invention, a wireless channel can be estimated and resources can be efficiently distributed among a plurality of users by forming a frame having a plurality of preambles and a super frame having a plurality of frames according to the present embodiment.

According to the present invention, it is also possible to allocate resources to other users between frames or between symbols, to effectively transfer information to all users in the same area with less overhead resources, and to maximize wireless channel performance through optimization on each of multi antennas in a wireless wideband multi-antenna system.

While the present invention has been described with respect to the specific embodiments, it will be apparent to those skilled in the art that various changes and modifications may be made without departing from the spirit and scope of the invention as defined in the following claims.

What is claimed is:

1. A method for forming a frame of a wireless communication system, comprising:
disposing a plurality of preamble symbols;
disposing a signal symbol at a predetermined position among the plurality of preamble symbols; and
disposing at least one of data symbols after the plurality of preamble symbols.

2. The method of claim 1, wherein the number of the preamble symbols is equal to or larger than the number of multi-antennas.

3. The method of claim 1, wherein the number of the data symbols varies independently according to a traffic amount of an uplink and a traffic amount of a downlink.

4. The method of claim 1, wherein each of the data symbols includes a plurality of pilot tones.

5. The method of claim 1, wherein the signal symbol is applied with a lowest modulation and coding scheme (MCS) level that supports the wireless communication system.

6. The method of claim 1, wherein if the frame is the downlink frame, the signal field includes at least one of information about a length of data transmitted through the signal field, which is expressed in bits, a number of terminals that will decode a corresponding frame, an index of combination used in a modulation combination set of a physical channel which is transmitted to corresponding terminals, information about a starting position of a symbol applied to a corresponding terminal in a data field, the number of symbols applied to a corresponding terminal, and cyclic redundancy checking (CRC) information for checking whether an error is generated in received signal field information.

7. The method of claim 1, wherein if the frame is an uplink frame, the signal field includes at least one of information about a length of data transmitted through the signal field, which is expressed in bits, a number of terminals that will decode a corresponding frame, an index of combination used in a modulation combination set of a physical channel which is transmitted to corresponding terminals, information about a starting position of a symbol applied to a corresponding terminal in a data field, the number of symbols applied to a corresponding terminal, information about a signal-to-noise ratio (SNR) of a downlink receiving signal, and cyclic redundancy checking (CRC) information for checking whether an error is generated in received signal field information.

8. A method for forming a frame of a wireless communication system, comprising:
disposing a plurality of uplink frames and a plurality of downlink frames with an inter frame space between each of the downlink frames and a corresponding uplink frames;
storing broadcast channel information in a data field of a first downlink frame; and
disposing at least one of short uplink frames after a last downlink frame.

9. The method of claim 8, wherein the uplink frame and the downlink frame include preamble fields having a plurality of preamble symbols, a signal field having one signal symbol between the preamble fields, and a data field having a plurality of data symbols after the preamble field.

10. The method of claim 8, wherein the short uplink frame include preamble fields having a plurality of preamble symbols, a signal field having one signal symbol between the preamble fields, and a data field having a plurality of data symbols after the preamble field.

11. The method of claim 10, wherein the short uplink frame is used to transfer bandwidth requirement information of users trying initial access and to transfer acknowledgment information of a terminal for downlink frames.

12. The method of claim 8, wherein the broadcast channel information includes frame resource allocation information, and information about positions and a number of short uplink frames.

13. The method of claim 12, wherein the information about positions and a number of the short uplink frames is information for enabling a user to perform an initial access without interfering with other users in communication.

14. The method of claim 8, wherein the broadcast channel information is a reference of a starting position of a frame.
